(19) United States
(12) Patent Application Publication
(10) Pub. No.: US 2019/0044465 A1
(43) Pub. Date: Feb. 7, 2019

(54) USE OF A CONTROL SYSTEM OF A POLYPHASE ROTARY ELECTRIC MACHINE COMPRISING PHASE SHORT-CIRCUIT MEANS, AND USE OF THE CORRESPONDING ROTARY ELECTRIC MACHINE

(71) Applicant: VALEO EQUIPEMENTS ELECTRIQUES MOTEUR, Creteil Cedex (FR)

(72) Inventors: Romuald MORVANY, Montigny Le Bretonneux (FR); Philippe MASSON, Yerres (FR); Guillaume DUTHILLEUL, Salles (FR)

(73) Assignee: VALEO EQUIPEMENTS ELECTRIQUES MOTEUR, Creteil Cedex (FR)

(21) Appl. No.: 15/755,971

(22) PCT Filed: Aug. 1, 2016
(86) PCT No.: PCT/FR2016/051999

§ 371 Date: Feb. 27, 2018

(30) Foreign Application Priority Data
Sep. 1, 2015 (FR) 1558088

(51) Int. Cl. H02P 9/00; F02N 11/04

(52) U.S. Cl. CPC H02P 9/006; H02P 2101/25; F02N 11/04

(57) ABSTRACT

The polyphase rotary electric machine wherein the invention is implemented comprises phase short-circuit means (15, 18) included in a control system (10). The machine is fitted in a motor vehicle, operates as a generator and is connected to an on-board electric network (2). The phase short-circuit means short-circuit at least one phase winding when a DC voltage measurement (B+) of the network, regulated by a regulator device, exceeds a predetermined threshold value and a phase current 15 in the phase winding is cancelled out and changes direction. According to the invention, the control system limits an overvoltage on the network due to an event other than load shedding.

### TECHNICAL FIELD OF THE INVENTION

The present invention relates to use of a system for controlling a polyphase rotary electrical machine comprising short-circuiting means, as well as to use of the corresponding rotary electrical machine in a motor vehicle.

### TECHNOLOGICAL BACKGROUND OF THE INVENTION

In a motor vehicle, an on-board network is used to supply power to the different items of electrical equipment with which the vehicle is equipped. The supply is provided by at least one battery. The latter is recharged by means of a rotary electrical machine, from the energy provided by the rotation of the thermal engine of the vehicle. Rotary electrical machine means in the most general manner any polyphase rotary electrical machine which is used for the production of direct power supplying the on-board network. In particular, it can be an alternator or also an alternator-starter.

In the event of sudden disconnection of an electrical charge of the on-board network, or of the battery, or of both, a phenomenon of load dump occurs which gives rise to an excess voltage on the on-board network. In fact, since regulation of an inductor current in the machine cannot act rapidly enough further to the load dump, the machine continues to supply the same output current, whereas the current consumption on the on-board network side has dropped.

Conventionally, the vehicle battery is a 12 V battery. In principle, thanks to its low internal resistance, it limits to approximately 17 V the voltage spikes which occur on the on-board network of the vehicle in the event of a load dump. This battery thus absorbs the small excess voltages. However, in the event of disconnection of the battery (because of breakage of a supply cable, for example), a very high excess voltage can occur on the on-board network. In fact, the current supplied by the machine charges the capacitors (including the parasitic capacitors) which are connected to the on-board network, and consequently makes a direct voltage on the on-board network increase significantly.

This excess voltage is liable to damage the electrical equipment supplied with power by the on-board network. This is why all the items of electrical equipment of the vehicle have dimensions such as to withstand a maximum voltage of approximately 32 V, which corresponds to an excess voltage of approximately 20 V.

Various solutions are known which make it possible to limit the voltage on the on-board network to a maximum permissible voltage, i.e. the highest voltage which the electrical equipment of the vehicle can withstand without risk of damage.

The solution which is described in the article “A New Design for Automotive Alternators” by D. J. Perreault et al published in the proceedings of the Congress “2000 International Congress on Transportation Electronics” (Convergence 2000), Detroit, Mich., October 2000, pp. 583-594, consists of blocking in the “on” state at least one of the transistors in switching of a switching rectifier. As a result, at least one of the phase windings is short-circuited. The short-circuit is maintained, and the excitation of the machine is decreased until the moment when the voltage has returned to an acceptable level.

This simple method for elimination of the transient effects caused by a load dump nevertheless has disadvantages:
the power supply to the equipment connected to the on-board network is not guaranteed because the excitation is not maintained;
the electrical and thermal protection of the semiconductor elements of the rectifier circuit is not ensured.

In patent application FR2975241, the company VALEO EQUIPEMENTS ELECTRIQUES MOTEUR discloses a method for controlling a polyphase rotary electrical machine operating as a generator, which eliminates these disadvantages.

This method consists of short-circuiting at least one phase winding in the event of a load dump, when a measurement of a network voltage exceeds a predetermined threshold value, and a phase current in this phase winding is cancelled and changes direction, such as to limit the excess voltage more rapidly than by means of regulation of the inductor current.

Since this method, and the system for controlling a polyphase rotary electrical machine which implements it, has given full satisfaction in the event of a load dump, the inventive body has considered it appropriate to generalise its usage.

### GENERAL DESCRIPTION OF THE INVENTION

The present invention thus relates to use of a system for controlling a polyphase rotary electrical machine comprising phase short-circuiting means.

The machine in question is coupled mechanically to a thermal engine of a motor vehicle, and operates as a generator connected to an on-board electrical network of the vehicle.

The phase short-circuiting means short-circuit at least one phase winding when a measurement of a network voltage, which is regulated by a regulation device of this machine, exceeds a predetermined threshold value, and a phase current in this phase winding is cancelled and changes direction.

According to the invention, the control system limits in general an excess voltage on the network caused by an event other than a load dump.

According to the invention, this control system is used with a polyphase rotary electrical machine which also comprises an excitation circuit supplied with power by an excitation module which produces a pulse-width modulated excitation current, and the event concerned is a fault of the excitation module and/or of the excitation circuit.

Also according to the invention, this control system is alternatively used with a polyphase rotary electrical machine which additionally comprises an excitation circuit supplied with power by an excitation module which produces a pulse-width modulated excitation current, and a loop for regulation of the regulation device which determines a duty cycle of the excitation current according to the output voltage, and the event concerned is a fault of this regulation loop.

Another use of this system for controlling a polyphase rotary electrical machine comprising phase short-circuiting means is advantageous when the event in question is assisted starting of the thermal engine.

Yet another use of this system for controlling a polyphase rotary electrical machine comprising phase short-circuiting means is also advantageous when the event in question is overspeed or racing of the thermal engine.

According to the invention, advantage is derived from use of a system for controlling a polyphase rotary electrical machine comprising phase short-circuiting means for the above events, with the machine additionally comprising:
a synchronous rectifier circuit with a plurality of branches each comprising at least one switch connected to the phase winding;
an electronic control circuit which opens or closes this switch by means of a synchronisation command,
   whereas the control system additionally comprises a control block associated with the switch forming phase short-circuiting means and generating a switching signal which closes the switch.

This control block comprises:
an excess voltage detection module generating an excess voltage signal representative of the presence of the excess voltage on the network for a first predetermined time;
a module for detection of passage through zero generating a signal of passage through zero representative of cancellation of the phase current;
an AND logic gate generating a short-circuiting command as output on the basis of the excess voltage signal and the signal of passage through zero as input;
a validation module generating a validated short-circuiting command authorising the stoppage of, or inhibition of, the short-circuiting command, according to a second predetermined time which is shorter than a first period necessary for detection of a phase fault by the regulation device, and according to a third predetermined time which is longer than a second period necessary for re-initialisation of this regulation device;
an OR logic gate generating the switching signal as output on the basis of the validated short-circuiting command and the synchronisation command.

In this use, the validation module comprises a counter which counts at a predetermined clock frequency during the second predetermined time, and counts down at this clock frequency during the third predetermined time.

Also in this use, the control block additionally comprises a memory comprising instructions representative of a specific processing of the event.

In all the uses concerned of a system for controlling a polyphase rotary electrical machine comprising phase short-circuiting means, this control system also comprises a module for filtering of the output voltage with a predetermined time constant.

The invention also relates to use of a polyphase rotary electrical machine comprising a control system comprising phase short-circuiting means, this machine of the excitation type being coupled mechanically to a thermal engine of a motor vehicle, and operating as a generator connected to an on-board electrical network of this vehicle.

These phase short-circuiting means short-circuit at least one phase winding when a measurement of a network voltage, regulated by a regulation device, exceeds a predetermined threshold value, and when a phase current in this phase winding is cancelled and changes direction.

According to the invention, this machine thus makes it possible to protect electrical equipment connected to the network in the event of an excess voltage on this network caused by an event other than a load dump, in particular a fault of an excitation circuit or of the regulation device, assisted starting of the jump start type, or overspeed or racing of the thermal engine of the vehicle.

These few essential specifications will have made apparent to persons skilled in the art the advantages provided by the invention in comparison with the prior art.

The detailed specifications of the invention are provided in the description which follows in association with the appended drawings. It should be noted that these drawings serve the purpose simply of illustrating the text of the description, and do not constitute in any way a limitation of the scope of the invention.

### BRIEF DESCRIPTION OF THE DRAWINGS

FIG. 1 shows an example of use according to the invention of a polyphase rotary electrical machine comprising a control system comprising phase short-circuiting means in a motor vehicle.

FIG. 2 is a process diagram of a system for controlling a polyphase rotary electrical machine comprising phase short-circuiting means known in the prior art and used in the application shown in FIG. 1.

FIG. 3 is a process diagram of a control block known in the prior art, of the control system shown in FIG. 2.

### DESCRIPTION OF PREFERRED EMBODIMENTS OF THE INVENTION

The uses of the system for controlling a polyphase rotary electrical machine comprising phase short-circuiting means, as described in the prior patent application by the inventive body, and referred to by the invention, correspond to a polyphase rotary electrical machine 1, of the alternator or alternator-starter type, supplying power to an on-board electrical network 2 connected to a battery 3.

The machine in question is preferably an excitation machine 1, a rotor 4 of which is coupled mechanically 5 to a thermal engine 6 of the vehicle.

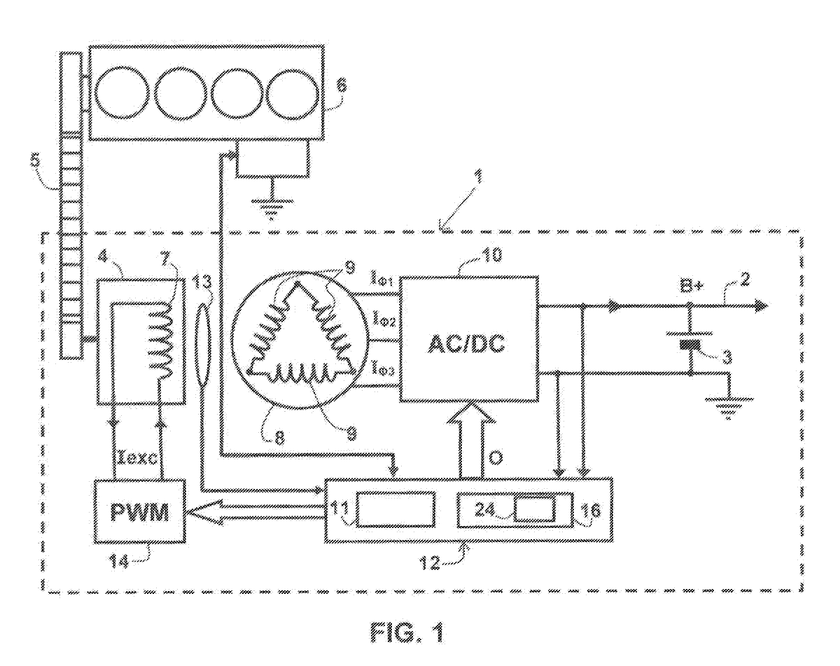

The rotor 4 comprises an excitation circuit 7, through which there passes an excitation current l_{exc}, creating in a known manner in a stator 8 with a number n of phase windings 9, a plurality of phase currents IΦ1, IΦ2, IΦ3, IΦn (n is preferably equal to 3, as represented in FIG. 1, but can be equal to 1).

The machine 1 comprises a synchronous rectifier circuit 10 connected to the phase windings 9 in order to rectify the phase currents IΦ1, IΦ2, IΦ3, IΦn, so as to supply the on-board network 2 with direct voltage B⁺ and charge the battery 3.

The direct voltage B+ is regulated by a device 11 for regulation of an electronic control unit 12, which, according to a speed of rotation of the rotor 4 determined by a speed sensor 13 and information exchanged with an interface housing of the thermal engine 6, optionally controls a duty cycle of the excitation current l_{exc} produced by an excitation module 14.

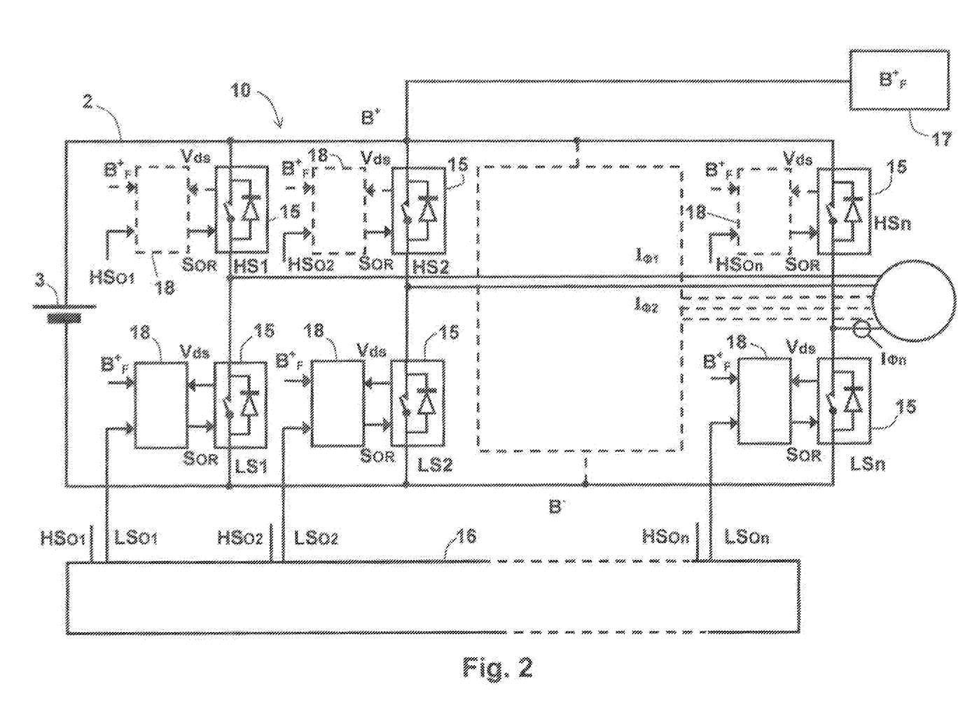

According to a known arrangement represented in FIG. 2, the synchronous rectifier circuit 10 has branches each comprising controllable switches 15, which connect the phase windings 9 firstly to the positive pole B⁺ of the battery 3 (switches HS1, HS2, HSn of the high side), and secondly to the negative pole B⁻ of the battery 3 (switches LS1, LS2, LSn of the low side).

In normal operation of the generator, an electronic control circuit 16 of the electronic control unit 12 closes and opens the high-side and low-side switches 15 alternately, according to a known operating mode of a synchronous rectifier 10, by means of synchronisation commands O.

In the event of excess voltage on the on-board network 2, one or a plurality of phase windings 9 is/are short-circuited, simultaneously or synchronously.

The short-circuiting is carried out equally well either on the basis of synchronisation commands O of the low-side switches LS_{O1}, LS_{O2}, LS_{On} (short-circuiting of n phases relative to the potential B⁻), or on the basis of synchronisation commands O of the high-side switches HS_{O1}, HS_{O2}, HS_{On} (short-circuiting of n phases relative to the potential B⁺).

The voltage B⁺_{F} which is used for the detection of excess voltage is the direct voltage B⁺ which is filtered by means of a filtering module 17, in order to eliminate the voltage ripple caused by the rectification, and in order to prevent the untimely short-circuitings of the “n” phases of the machine.

According to the structure of the system, this measurement is:

Single. In this case, a switching signal S_{OR} of the “n” controllable components, generated on the basis of the synchronisation commands O, is virtually synchronous;

Plural. In this case, the switching signal S_{OR} of the “n” controllable components is asynchronous, and depends both on the structure of the system and on the tolerances of the components which permit the “n” detections of excess voltage which the system comprises.

In the system for controlling the machine 1 used by the invention, it should be remembered that the short-circuiting is commanded when this measurement exceeds a predetermined threshold value, and when a phase current IΦ1, IΦ2, IΦ3, IΦn in the phase winding 9 is cancelled and changes direction.

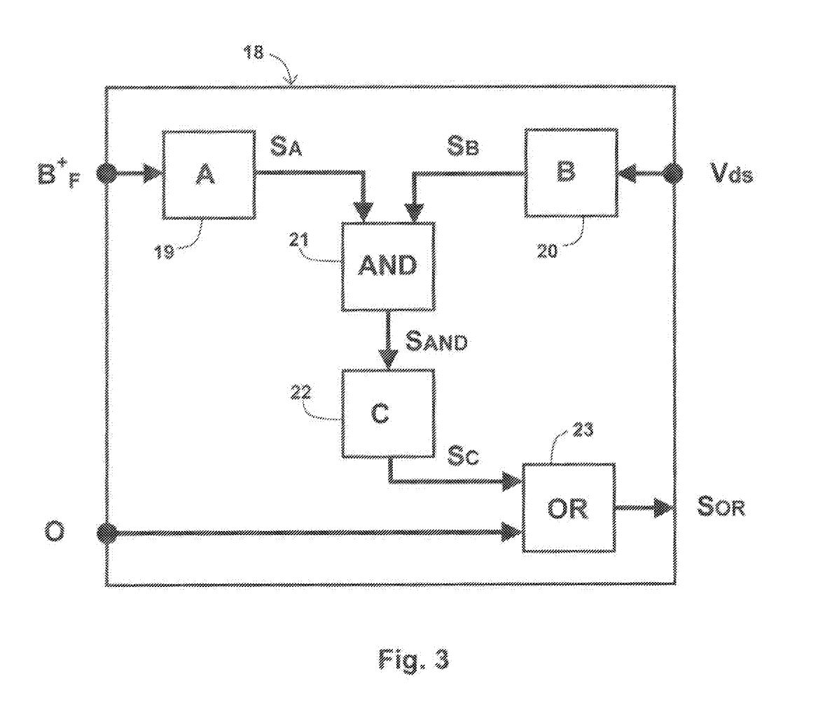

As shown in FIG. 2, the switching signal S_{OR} of each switch 15 is processed by a control block 18, the details of which are represented in FIG. 3, on the basis of the synchronisation commands O.

It will be appreciated that only the low-side control blocks 18 or the high-side control blocks 18 (represented in broken lines) exist, depending on whether the short-circuiting of the phase windings 9 is carried out relative to B⁻ or B⁺, respectively.

This control block 18 comprises an excess voltage detection module 19 which generates an excess voltage signal SA representative of a presence of an excess voltage on the network 2 during a first predetermined time, the operation of which will not be described here.

The control block 18 also comprises a module 20 for detection of passage through zero of the phase current IΦ1, IΦ2, IΦ3, IΦn which generates a signal S_{B} of passage through zero.

A plurality of methods can be used to detect the variation of the phase current IΦ1, IΦ2, IΦ3, IΦn, in particular a direct measurement of the phase current IΦ1, IΦ2, IΦ3, IΦn.

Preferably, the block 20 for detection of passage through zero uses a voltage drop Vds at the terminals of the switch 15 which is controlled.

As indicated, use is made of the general principle consisting of generating a command S_{AND} for short-circuiting a phase winding 9 when the excess voltage is detected on the on-board network 2, and when the phase current IΦ1, IΦ2, IΦ3, IΦn is cancelled and changes direction.

As shown clearly in FIG. 3, the control block 18 thus comprises an AND logic gate 21 which generates this short-circuiting command S_{AND} on the basis of the excess voltage signal SA and the signal S_{B} of passage through zero at the input.

This command S_{AND} for short-circuiting of the short-circuit SA is not applied directly to the switch 15, but is validated, stopped, or inhibited by a validation module 22 of the control block 18.

A characteristic of this type provides numerous advantages when the excess voltage is caused by a load dump. Numerous tests have led the inventive body to use the system 10 for controlling a rotary electrical machine 1 with this characteristic also in order to limit excess voltages with different causes.

In the motor vehicle field, persons skilled in the art are familiar with a plurality of events, in addition to a load dump, which are responsible for excess voltages on the on-board network of a motor vehicle, which excess voltages cannot be compensated for by the device 11 for regulation of the machine 1, either because they occur too rapidly, or because they are too great, or because of a fault of the regulation device 11 itself.

An event of this type is a fault of the excitation module 14 or a breakdown of a regulation loop of the regulation device 11 which leaves the excitation “full field”. In this case, the direct voltage B⁺ can no longer be regulated, and the only way of limiting the excess voltage on the network 2 is to use the control system 10, making it possible to short-circuit the phases 9.

An external event which can give rise to an excess voltage on the on-board electrical network 2 is assisted starting of the thermal engine 6 by an external battery connected by cables to the battery 3, particularly if this external battery is an on-board battery of another vehicle, the own thermal engine of which is running (jump start circumstance). Use of the control system 10 short-circuiting the phases 9 in the event of excess voltage makes it possible to protect the equipment connected to the network 2, without a motor vehicle manufacturer needing to provide terminals for connection to the network 2 which are dedicated to the jump start.

Another event which is liable to give rise to an excess voltage on the on-board electrical network is a sudden overspeed or racing of the thermal engine due to a mechanical cause. In this case, cancellation of the excitation current by the regulation device 11, triggered by detection of the overspeed or racing by the rotation speed sensor 13, may not be sufficient to prevent an excess voltage if the rotor comprises interpolar magnets. The use of the control system 10 short-circuiting the phases 9 in this situation also makes it possible to protect the equipment connected to the network 2, without the motor vehicle manufacturer needing to provide a mechanism for mechanical uncoupling of the electrical machine 2 from the thermal engine 6.

Taking into account the results of the tests carried out by the inventive body, the control module 16 consequently comprises this validation module 22, which serves the purpose of preventing false detections of a “phase fault” in these numerous circumstances by the device 11 for regulation of the direct voltage B⁺ of the machine 1, by limiting the duration of the short-circuiting command S_{AND} to a second predetermined time. This second predetermined time is shorter than a first period necessary for detection of this fault by the regulation device 11.

In order to allow the device 11 for regulation of the machine 1 to re-initialise correctly after forcing of stoppage of the validated short-circuiting command S_{C}, the short-circuiting command S_{AND} is inhibited during a third predetermined time. This third predetermined time is longer than a second period necessary for the re-initialisation.

In the validation module 22, the second and third predetermined times are counted respectively by a counter and a down-counter at the same clock frequency.

An OR logic gate 23 of the control block 18 superimposes the validated short-circuiting command S_{C} on the synchronisation command O obtained from the electronic control circuit 16, in order to generate the switching signal S_{OR} applied to the switches 15.

In a manner which in itself is known, the control blocks 18 are preferably provided by means of a microcontroller or an ASIC specific to the use.

In the case of implementation by a microcontroller, a memory 24 advantageously comprises the instructions representative of processing which is specific to the different events which generate the excess voltages.

As will be appreciated, the invention is not limited simply to the above-described preferred embodiments.

On the contrary, the invention thus incorporates all the possible variant embodiments which would remain within the context defined by the following claims.

1. Polyphase rotary electrical machine (1) comprising a control system (10) comprising phase short-circuiting means (15, 18), said machine (1) of the excitation type being coupled mechanically to a thermal engine (6) of a motor vehicle, and operating as a generator connected to an on-board electrical network (2) of said vehicle, said phase short-circuiting means (15, 18) short-circuiting at least one phase winding (9) when a measurement of a direct voltage (B+) of said network (2), regulated by a regulation device (11), exceeds a predetermined threshold value, and when a phase current (IΦ1, IΦ2, IΦ3, IΦn) in said phase winding (9) is cancelled and changes direction, wherein said machine (1) protects, by means of said phase short-circuiting means (15, 18), electrical equipment connected to said network (2) in the event of an excess voltage on said network (2) caused by at least one event from amongst the following: a fault of an excitation circuit (7), a fault of said regulation device (11), assisted starting of the jump start type, overspeed, or racing of said thermal engine (6).

2. Machine according to claim 1, wherein it additionally comprises:
a synchronous rectifier circuit (10) with a plurality of branches each comprising at least one switch (15) connected to said phase winding (9);
an electronic control circuit (16) which opens or closes said switch (15) by means of a synchronisation command (O);
and wherein said control system (10) additionally comprises a control block (18) associated with said switch (15) forming said phase short-circuiting means (15, 18) and generating a switching signal (SO) which closes said switch (15), said control block (18) comprising:
an excess voltage detection module (19) generating an excess voltage signal (SA) representative of the presence of said excess voltage on said network (2) for a first predetermined time;
a module (20) for detection of passage through zero (SB) generating a signal of passage through zero (SB) representative of cancellation of said phase current (IΦ1, IΦ2, IΦ3, IΦn);
an AND logic gate (21) generating a short-circuiting command (SAND) as output on the basis of the excess voltage signal (SA) and said signal of passage through zero (SB) as input;
a validation module (22) generating a validated short-circuiting command (SC) authorising the stoppage of, or inhibition of, said short-circuiting command (SAND), according to a second predetermined time which is shorter than a first period necessary for detection of a phase fault by said regulation device (11), and according to a third predetermined time which is longer than a second period necessary for re-initialisation of said regulation device (11);
an OR logic gate (23) generating said switching signal (SOR) as output on the basis of said validated short-circuiting command (SC) and said synchronisation command (O).

3. Machine according to claim 2, wherein said validation module (22) comprises a counter which counts at a predetermined clock frequency during said second predetermined time, and counts down at said clock frequency during said third predetermined time.

4. Machine according to claim 2, wherein said control block (18) additionally comprises a memory (24) comprising instructions representative of a specific processing of said event.

5. Machine according to claim 1, wherein said control system (10) also comprises a module (17) for filtering of said direct voltage (B+) of said network (2) with a predetermined time constant.

6. Machine according to claim 3, wherein said control block (18) additionally comprises a memory (24) comprising instructions representative of a specific processing of said event.

7. Machine according to claim 2, wherein said control system (10) also comprises a module (17) for filtering of said direct voltage (B+) of said network (2) with a predetermined time constant.

8. Machine according to claim 3, wherein said control system (10) also comprises a module (17) for filtering of said direct voltage (B+) of said network (2) with a predetermined time constant.

9. Machine according to claim 4, wherein said control system (10) also comprises a module (17) for filtering of said direct voltage (B+) of said network (2) with a predetermined time constant.
